(19) United States
(12) Patent Application Publication
(10) Pub. No.: US 2007/0202898 A1
(43) Pub. Date: Aug. 30, 2007

(54) Apparatus and method for supporting multimedia service in mobile terminal

(75) Inventors: Sang Won Bae, Seoul (KR); Jae Joon Hwang, Seoul (KR); Sun Young Yi, Seoul (KR); Byeong Cheol Hwang, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/704,694

(22) Filed: Feb. 9, 2007

(30) Foreign Application Priority Data
Feb. 9, 2006 (KR) 2006-0012341

(51) Int. Cl. H04Q 7/20

(52) U.S. Cl. 455/466

(57) ABSTRACT

An apparatus and a method for supporting a multimedia service which is capable of collecting opinions on a certain subject by receiving an opinion message in response to an opinion request message attached a plurality of images transmitted together with check widgets is provided. The method includes preparing at least two images, attaching at least two prepared images as thumbnail images to the multimedia service message for display at the same time, and transmitting the multimedia service message with the images. Accordingly, the user can make a decision, by negotiating with the counterpart user, on a subject such as a purchase of goods or a selection of foods.

### PRIORITY

This application claims priority under 35 U.S.C. §119 to an application entitled “Apparatus And Method For Supporting Multimedia Service In Mobile Terminal” filed in the Korean Intellectual Property Office on Feb. 9, 2006 and assigned Serial No. 2006-0012341, the contents of which are incorporated herein by reference.

### BACKGROUND OF THE INVENTION

1. Field of the Invention

The present invention relates to a Multi Media Service (MMS) of mobile communication system, and more particularly, to an apparatus and method for supporting MMS with message exchange between the mobile terminals.

2. Description of the Related Art

In order to overcome the slowdown with the voice communication and to increase selling per subscriber, various research has been done in consideration with the mobile Internet services. One of the sources creating profit is the multimedia service providing contents such as bell sounds, characters, photos, Video On Demand (VOD), etc. The mobile Internet multimedia service can be provided in two manners. Firstly, the user can be provided with the multimedia service by connecting to a wireless Internet server with the mobile terminal such as a cellular phone, a Personal Communication Service (PCS) phone, Personal Digital Assistant (PDA), and the like.

As mentioned above, the typical multimedia services have been provided by downloading the contents from the WAP server or the Internet portal site. Recently, however, the mobile terminals have been basically equipped with a camera such that the photographs taken with the camera itself can be used as the multimedia contents. That is, the photographs taken with a built-in camera can be managed in the user's album, displayed on a screen as background image, and transmitted to a counterpart subscriber.

In such manner, it is possible to use the photographs taken by the mobile terminal for various purposes and multimedia services without support of the additional network element such as the WAP server or other web portal server.

In other cases, predetermined images can be used as a background of a Short Message Service (SMS), which is called a color mail service, or the images taken by the built-in camera can be attached to the short message.

Typically, when a user asks something with the images attached to the message while the users exchange messages, the counterpart user responses with a text message or voice call. However, if the number of images to be transmitted increases, especially with asking certain opinions about images, the exchanges of the images and opinions about the images between the users may become very time consuming and involve bothersome operations.

### SUMMARY OF THE INVENTION

The present invention has been made in an effort to solve the above problems, and it is an object of the present invention to provide an apparatus and method for supporting a multimedia service which is capable of collecting opinions of a counterpart user by transmitting a plurality of images taken by a built-in camera of a mobile terminal as an picture comparison request.

It is another object of the present invention to provide an apparatus and method for supporting a multimedia service which is capable of collecting opinions on a certain subject by receiving an opinion message in response to a picture comparison request message attached a plurality of images.

It is still another object of the present invention to provide an apparatus and method for supporting a multimedia service which allows a user to send a picture comparison request message having images on a certain subject such as foods and commercial goods immediately taken by a camera built into the mobile terminal and to receive an opinion message from a counterpart user in response to the comparison request message.

The above objects of the present invention are achieved by a method for transmitting a multimedia service message in a mobile terminal according to the present invention. The method includes preparing at least two images, attaching at least two images among the prepared images as thumbnail images to the multimedia service message so as to be displayed at the same time, and transmitting the multimedia service message with the images.

Preferably, the method further includes setting a number of the images to be attached to the MMS message and assigning a check widget to each image attached to the multimedia service message.

Preferably, the multimedia service message is transmitted with information for displaying the check widgets.

Preferably, the method further includes entitling the images attached to the multimedia service message, distinguishing the phone number of the counterpart users by individual or group, enlarging the images if it is required while comparing the images, and transmitting the multimedia service message with image selection factors (check widgets).

In another aspect of the present invention, the apparatus for transmitting a multimedia service message in mobile terminal includes an image-preparing unit which prepares images to be transmitted with the multimedia service message, an image integration unit which attaches at least two images among the images prepared by the image-preparing unit as thumbnail images to the multimedia service message so as to be displayed at the same time, and a transmit unit which transmits the multimedia service message with the images.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 is a block diagram of components of a mobile phone according to the present invention;

FIGS. 2A and 2B are flowcharts illustrating a method for transmitting the picture comparison MMS image at the transmitter according to the present invention;

FIG. 3 is a flowchart illustrating a procedure for transmitting a response message, at the receiver, in response to the picture comparison MMS image;

FIG. 4 is a drawing illustrating a process for creating and transmitting the picture comparison MMS image; and

FIG. 5 is a drawing illustrating a process for creating and transmitting the response message to the transmitter.

### DETAILED DESCRIPTION OF THE PREFERRED EMBODIMENTS

Reference will now be made in detail to the preferred embodiments of the present invention, examples of which are illustrated in the accompanying drawings.

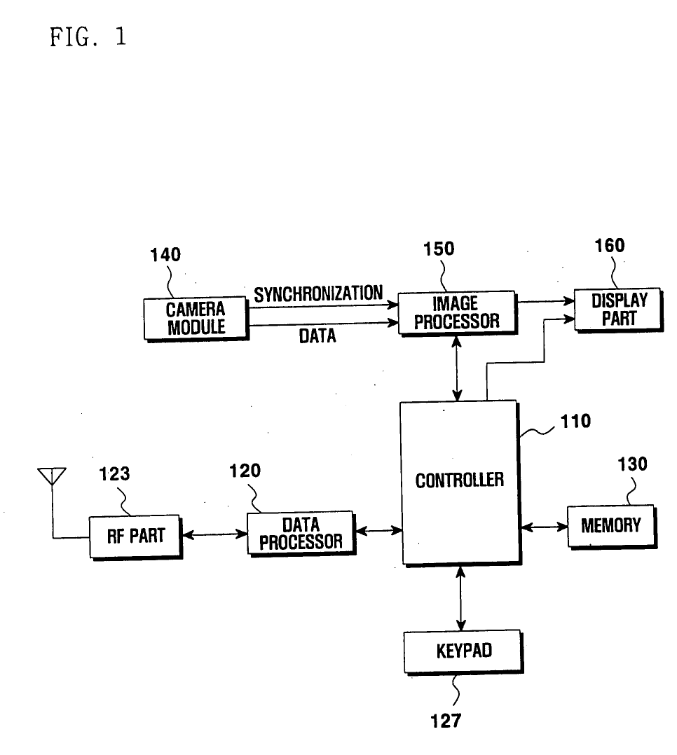

FIG. 1 is a block diagram of components of a mobile phone according to the present invention.

Referring to FIG. 1, the mobile phone includes a controller 110, a data processor 120, a Radio Frequency (RF) part 123, a keypad 127, a memory 130, a camera module 140, an image processor 150, and a display part 160.

The RF part 123 operates at predetermined frequencies dependent on the communication regulation. The RF part 123 includes a RF transmitter which up-converts and amplifies the signal to be transmit and a RF receiver which low-noise-amplifies and down-converts the signal received through an antenna. Also, the RF part 123 of the mobile phone communicates the MMS messages with a counterpart mobile phone in association with the present invention.

The data processor 120 includes a transmitter which performs encoding and modulation on the signal to be transmitted and a receiver which performs demodulation and decoding on the received signal.

The memory 130 is provided with a program memory part and a data memory part. The program memory part stores programs for controlling the typical operations of the mobile phone and a program for processing picture comparison MMS according to an embodiment of the present invention. Also, the data memory part stores the data generated while executing the programs, a plurality of thumbnail images taken by the built-in camera module, and the information used, by individual or group, for the picture comparison MMS received with the phone book function.

The controller 110 controls the overall operations of the mobile phone. The controller 110 can include the data processor 120. Also, the controller 110 configures the picture comparison MMS, controls the camera module 140 for taking photos and the memory for storing the taken photos as identical category images, and displays the images on the display part 160 with an opinion request message as the picture comparison MMS. Also, the controller 110 provides control such that the picture comparison MMS is transmitted to the counterpart terminal through the RF part 123 and the data processor 120 together with a check widget and that an opinion is received through the RF part 123 and the data processor 120 in response to the picture comparison MMS. The opinion is displayed on the display part 160 under the control of the controller 110. The controller 110 controls the operations of the mobile phone according to the instruction inputted through the keypad 127 and adds a message inputted through the keypad 127 onto the picture comparison MMS.

The camera module 140 takes the images for the picture comparison MMS and has a camera sensor for converting the optical signals obtained through lenses into electrical signals, and the camera sensor has a signal processing part for converting the analog video signal taken by the camera module into digital data. Here, the camera sensor is a Charge Coupled Device (CCD) sensor, and the signal processing part can be implemented with a Digital Signal Processor (DSP). Also, the camera sensor and the signal processing part can be implemented integrally or separately.

The image processor 150 generates frame data for displaying the picture comparison MMS image outputted from the camera module 140 under the control of the controller 110. The image processor 150 makes the image outputted from the camera module 140 into thumbnail images and processes the thumbnail images frame by frame so as to output the thumbnail images in consideration of the characteristics and size of the display part 160, under control of the controller 110. Also, the image processor 150 can compress the picture comparison MMS image in a predetermined method and recover the compressed data into the original picture comparison MMS image. Also, the image processor 150 can display the check widget on the thumbnail image as a background image in order for the user or the counterpart user to carry out a selection.

The display part 160 displays the picture comparison MMS thumbnail image and the user data outputted from the controller 110 onto the screen. Here, the display part 160 can be a Liquid Crystal Display (LCD), which includes an LCD controller, a memory for storing the picture comparison MMS image, and an LCD device. When implementing the LCD with a touch screen mechanism, it can work as an input device.

The keypad 127 includes a plurality of number and character keys and function keys for manipulating the corresponding functions. The keypad 127 is implemented so as to input instructions for all of the functions, to write opinions and response messages, to input the title of the image, to designate the picture comparison MMS mode, and to carry out the selection with the check widget, according to the embodiment of the present invention.

Picture Comparison MMS Image Transmission

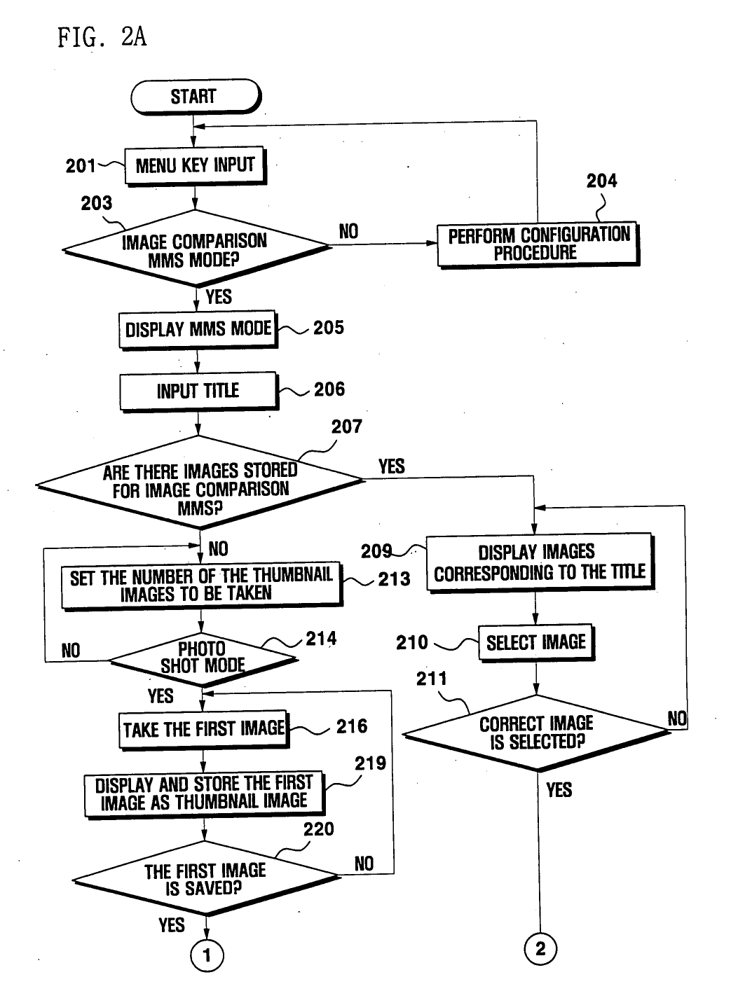

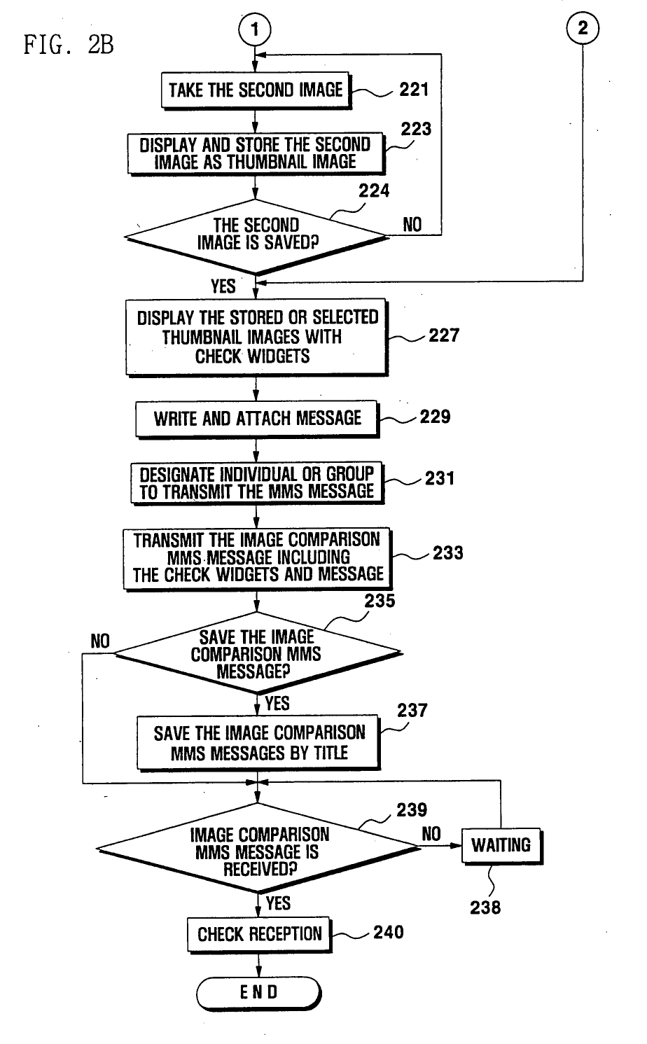

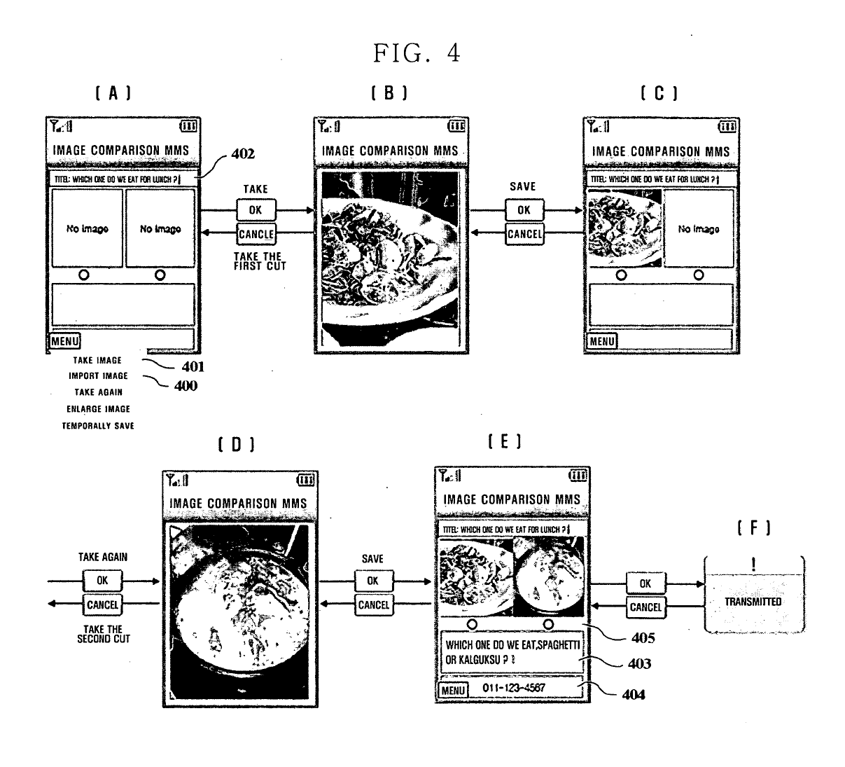

FIG. 2 is a flowchart illustrating a method for transmitting the picture comparison MMS image at the transmitter according to an embodiment of the present invention, and FIG. 4 is a drawing illustrating a process for creating and transmitting the picture comparison MMS image.

In regard to FIG. 4, the user prepares two frames for pictures to be compared with each other and types a title 402 at step (a) of FIG. 4. The pictures can be obtained in two ways. One is to photograph the subject using the built-in camera and the other is to import the picture stored in the memory. If the user fails to take the photograph, it can be retried. For example, the picture can be taken by selecting a menu item “take target object” 401 so as to obtain the picture at step (b). The picture displayed on the screen fills out the first frame at step (c) by the user pushing the OK key. If a cancel key is pushed at step (b) or (c), the screen returns to step (a).

After obtained the first picture, a second picture is obtained in the identical manner at step (d) so as to fill out the second frame at step (e). Below the frames, a check widget 405 is positioned in order for the user to select one of the frames (pictures). Also, a message box 403 is positioned below the check widget in order for the user to type a message. The message may request an opinion on a subject associated with the pictures, for example, “Which one do we eat, Spaghetti or Kalguksu?,” “could you select which one is much pretty?,” “which one do you want?,” “please select one matching my style,” “flower pattern one piece Vs. stripe one piece?,” and “which style is fit for me, bob cut vs. setting permanent?” If the user pushes the OK key after typing the phone number of the counterpart user, the pictures and the check widget are transmitted, together with the message, as a single picture comparison MMS image.

Accordingly, as shown in FIG. 2A, if a menu key is inputted at step 201, the controller determines whether the picture comparison MMS mode is activated at step 203. If the picture comparison MMS mode is not activated, the controller 110 performs a configuration of the picture comparison MMS mode at step 204. It is determined that the mobile phone is in the picture comparison MMS mode, the controller 110 displays the image of step (a) of FIG. 4 on the display part 160 at step 205 and then allows the title to be written through the keypad 160 at step 206. Sequentially, the controller 110 determines whether any previously stored picture exists in the memory at step 207. If it is determined that there is a previously stored picture, the controller 110 displays the thumbnail image corresponding to the title on the display part 160 as in (a) of FIG. 4 and displays the image to be compared, as in (b) of FIG. 4, at step 210. On the other hand, if there is no previously stored picture at step 207, the picture to be compared can be taken with the camera as in (a) of FIG. 4. The controller 110 configures the number of the thumbnail pictures to be taken upon entering the photo shot mode at step 213 and then checks whether the camera module is prepare for taking photographs at step 214. The order of configuration of processes 213 and 214 for the photo shot mode and the number of the pictures to be taken can be changed. That is, the number of the pictures to be taken can be designated after entering the photo shot mode. This results in the same effect.

In the photo shot mode, the first and second pictures are sequentially obtained by being taken at steps 216 and 221 (FIG. 2B) and then stored at steps 219 and 223, respectively. The first picture taken at step 216 through the camera module 140 and the image processor 150 is displayed on the display part 160 as the thumbnail image as in (b). The thumbnail image is stored as in (c) of FIG. 4 after being checked at step 220. The second picture is obtained in an identical manner such that the second picture is taken at step 221, displayed as a thumbnail image at step 223, and stored after being checked at step 224. The controller 110 reads the previously stored pictures or the pictures taken at steps 216 and 221 from the memory 130 and then displays, as in (e) of FIG. 4, the pictures onto the display part together with the check widget 405 in order for the user to choose one of the pictures at step 227. The message 403 is then written through the keypad 127 as in (e) of FIG. 4 at step 229. The written message is added to the thumbnail image selected by under the control of the controller 110.

The phone number(s) 404 of the counterpart user can be directly inputted through the keypad 127 as in (e) of FIG. 4 or loaded from the phone book stored in the memory 130 individually or by group, such that the pictures, the messages, and the check widget are transmitted at the same time as the picture comparison MMS image.

The controller 110 determines whether to store the transmitted picture comparison MMS image at step 235. If it is determined that the picture comparison MMS image will be stored, the controller classifies and stores the images by title at step 237.

Also, the controller 110 determines whether there is any image or message checked with the check widget from the message received in response to the picture comparison MMS image at step 239. If there is any checked image or message, the controller 110 displays the received messages so as to help the user to make decision on the subject. In business, this service can be used for helping the client to select one of several items in any category such as a gift, shopping, food, meeting, cloth, hair style, electric appliance, shoes, ring, and etc or to make a decision on a subject such as design, color, style, and etc. If there is no response from the counterpart user at step 239, the mobile terminal stays in waiting mode at step 238.

Response Mode After Receiving the Picture Comparison MMS Image

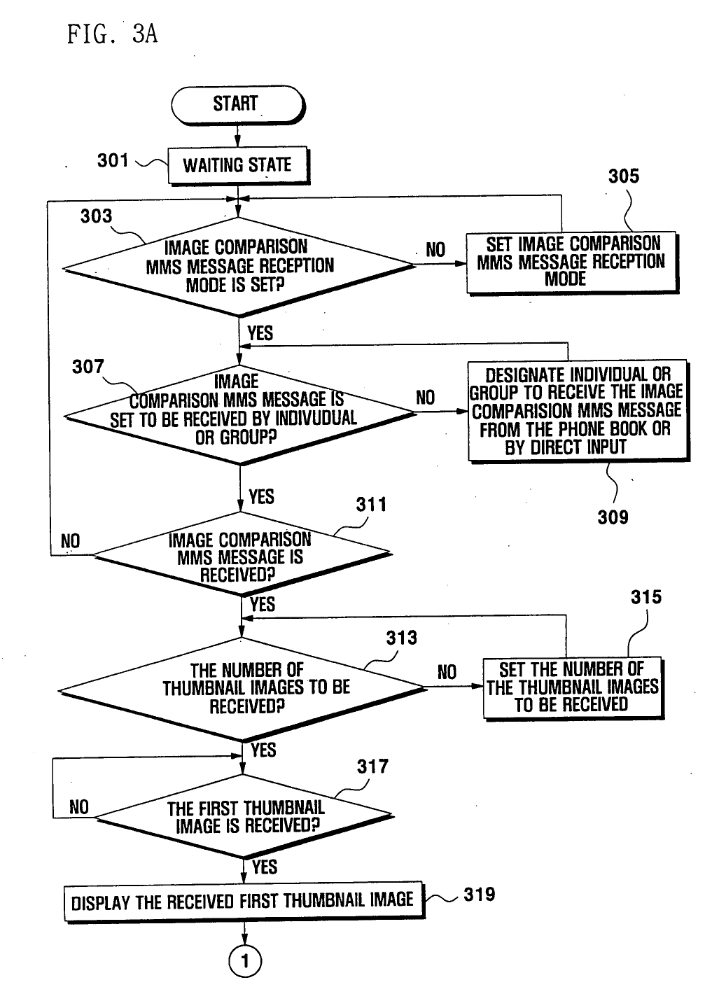

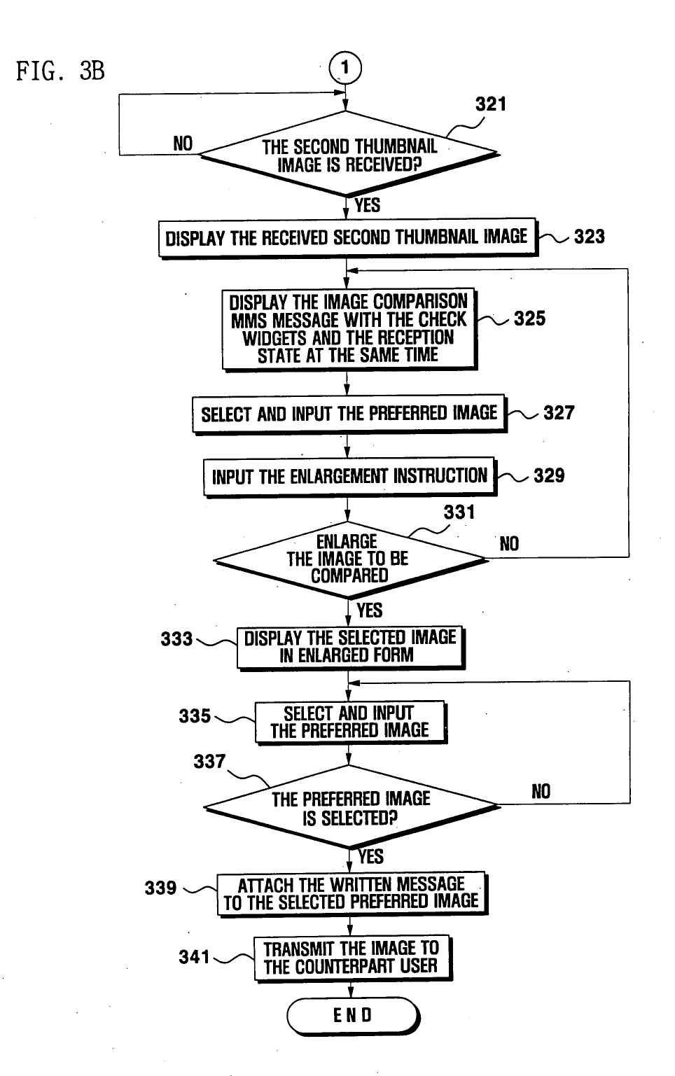

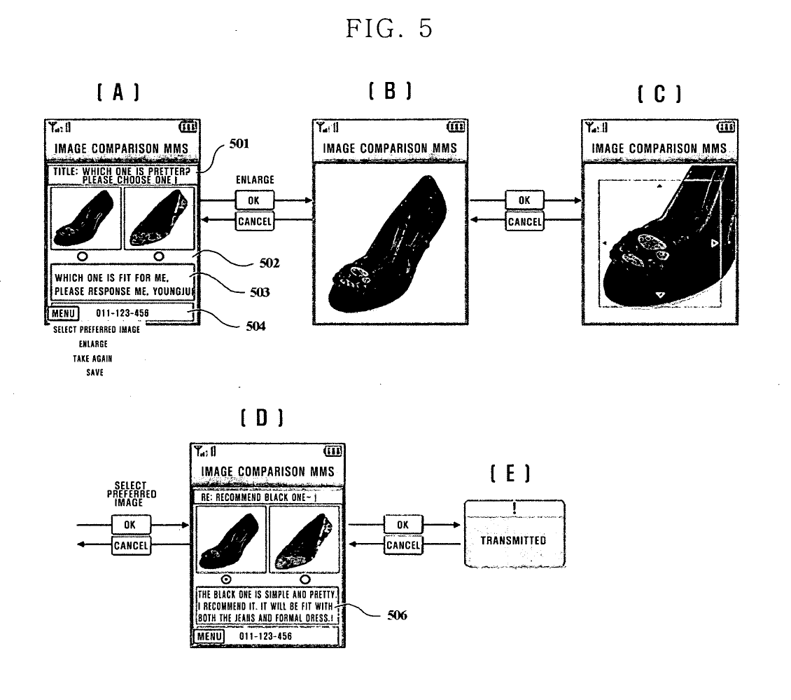

FIG. 3 is a flowchart illustrating a procedure for transmitting a response message, at the receiver, in response to the picture comparison MMS image, and FIG. 5 is a drawing illustrating a process for creating and transmitting the response message to the transmitter.

Upon receiving the picture comparison MMS image as in (e) of FIG. 4, the counterpart terminal displays the received picture comparison MMS image through the display part 160 as in (a) of FIG. 5 such that the counterpart user can select an item with the check widget 502 after checking the title 501, two pictures, and the message 503 (“Which one is fit for me, please respond, Youngju”). The receiver can determine whether to store the picture comparison MMS image on the basis of the phone number by individual or group. The picture can be enlarged as in (b) of FIG. 5 by selecting an area and pushing the OK key, and can further enlarged so as to see in more detail as in (c) of FIG. 5. The counterpart user can select one of the pictures with the check widget 503 as in (d) of FIG. 5, and then write a response message (for example, “The black one is simple and pretty. I recommend it. It will be fit with both the jeans and formal dress.”) 506 as in (d) of FIG. 5.

Accordingly, as shown in FIG. 3A, the controller 110 of the mobile phone determines whether the picture comparison MMS reception mode is set at step 303 during the waiting mode of step 301. If the picture comparison MMS reception mode is not set, the controller 110 controls so as to set the picture comparison MMS reception mode at step 305. On the other hand, if the picture comparison MMS reception mode is set, the controller 110 determines whether the picture comparison MMS image is set to be received by individual or group at step 307. If there are no settings, an individual or group to receive the picture comparison image can be imported from the memory or directly inputted through the keypad.

The controller 110 checks the settings at step 307 and determines whether the picture comparison MMS image as in (a) of FIG. 5 is received. If the picture comparison MMS image is received, the controller 110 determines the number of the thumbnail images to receive at steps 313 and 315. If the number of the thumbnail images is not provided, the controller 110 sets the number of the thumbnail images at step 315 before receiving the thumbnail images. If the number of the thumbnail images is 2, the controller 110 receives the first thumbnail image at step 317 and displays the first thumbnail image at step 319. The controller 110 receives the second thumbnail image at step 321 (FIG. 3B) and then displays the second thumbnail image at step 323. In a special case, the first and second thumbnail images can be received at the same time with a special setting.

The controller 110 controls the display of the check widget, the thumbnail images, and the message through the display part 160 at the same time. Sequentially, the controller 110 receives an instruction for selecting one of the images through the keypad 127 at step 327 and checks that there is an input for enlarging the image at step 331 if there is a designation of a key for enlarging the image at step 329. If it is determined that there is an input for enlarging the image, the controller 110 controls the display part 160 to display the enlarged image as in (b) of FIG. 5 at step 333. As illustrated in (c) of FIG. 5, the controller 110 can further enlarge the image with predetermined settings. If there is an input for selecting one of the image through the keypad 127 as in (d) of FIG. 5 at step 335 and an OK key is pushed at step 337, the controller 110 allows the user to write the message 506 as in (d) of FIG. 5 and then transmits the message together with the respond image at step 341. The transmitter at step 239 of FIG. 2 checks this message.

In the present invention, more than two pictures are sequentially taken by camera or loaded from the memory and transmitted, as thumbnail image which supports enlargement, together with the check widget. The counterpart user receives the pictures, select preferred one of the pictures with the check widget, and feedback the selection result. The selection result helps the user to make a decision.

The foregoing embodiments are merely exemplary and are not to be construed as limiting the present invention. The present teachings can be readily applied to other types of apparatus. The description of the present invention is intended to be illustrative, and not to limit the scope of the claims. Many alternatives, modifications, and variations will be apparent to those skilled in the art.

As described above, in the method for supporting a multimedia service of the present invention, a user transmits more than two images to the counterpart user together with a message soliciting opinion on the images such that the opinions received in response to the images help the user to make a decision, whereby the present invention is advantageous to allow people to share fun when choosing gift, food, cloth, hair style, etc., or to help a buyer to make a decision on a subject in business.

What is claimed is:

1. A method for transmitting a multimedia service message in a mobile terminal, comprising:
preparing at least two images;
attaching at least two of the prepared images as thumbnail images to the multimedia service message for display at the same time; and
transmitting the multimedia service message with the thumbnail images.

2. The method of claim 1, further comprising setting a number of thumbnail images to be attached to the MMS message.

3. The method of claim 1, further comprising assigning a check widget to each image attached to the multimedia service message.

4. The method of claim 3, wherein the multimedia service message is transmitted with information for displaying the check widgets.

5. The method of claim 1, further comprising setting a number of thumbnail images to be displayed at the same time.

6. The method of claim 5, wherein the number of the thumbnail images are displayed in a sequential order at the same time.

7. The method of claim 1, wherein each thumbnail image can be displayed in an enlarged form.

8. The method of claim 1, wherein the multimedia service message is transmitted with text information.

9. A method for receiving a multimedia service message in a mobile terminal, comprising:
receiving the multimedia service message having at least two images; and
displaying at least two of the images included in the multimedia service message at the same time.

10. The method of claim 9, wherein the multimedia service message includes a check widget for each image included in the multimedia service message.

11. The method of claim 10, wherein the multimedia service message includes information for displaying the check widget.

12. The method of claim 9, further comprising setting a number of thumbnail images to be displayed at the same time.

13. The method of claim 12, where the number of thumbnail images are displayed in a sequential order at the same time.

14. The method of claim 13, wherein each thumbnail image can be displayed in an enlarged form.

15. The method of claim 9, wherein the multimedia service message includes text information.

16. The method of claim 9, further comprising selecting one of the images included in the multimedia message as a preferred image.

17. The method of claim 16, further comprising feeding back information on the preferred image in response to the received multimedia service message.

18. An apparatus for transmitting a multimedia service message in mobile terminal, comprising:
an image-preparing unit which prepares images to be transmitted with the multimedia service message;
an image integration unit which attaches at least two of the images prepared by the image-preparing unit as thumbnail images to the multimedia service message to be displayed at the same time; and
a transmit unit which transmits the multimedia service message with the images.

19. The apparatus of claim 18, further comprising an image counter which sets a number of the images to be attached to the multimedia service message.

20. The apparatus of claim 18, further comprising a check widget-assigning unit which assigns a check widget to each image attached to the multimedia service message.

21. The apparatus of claim 18, further comprising an image counter which sets a number of thumbnail images to be displayed at the same time.
